(19) United States
(12) Patent Application Publication
(10) Pub. No.: US 2004/0175462 A1
(43) Pub. Date: Sep. 9, 2004

(54) Frozen dessert, process for producing it and container for packaging and distributing it

(76) Inventors: Philippe Jerome Didier Riviere, Toulouse (FR); Stephane Silvente, Toulouse (FR); Frank Manuel Tonon, Guichainville (FR); Veronique Suzanne Michele Andre-Linet, Gravigny (FR)

Correspondence Address: WINSTON & STRAWN, PATENT DEPARTMENT, 1400 L STREET, N.W., WASHINGTON, DC, 20005-3502, US

(21) Appl. No.: 10/802,865

(22) Filed: Mar. 18, 2004

Related U.S. Application Data
(63) Continuation of application No. PCT/EP02/10252, filed on Sep. 9, 2002.

(30) Foreign Application Priority Data
May 6, 2002 (FR) 0205620
Sep. 19, 2001 (FR) 0112106

(51) Int. Cl. A23G 1/00

(52) U.S. Cl. 426/100

(57) ABSTRACT

The invention relates to a frozen dessert, which, independently of any incorporation of gas, is malleable and extrudable at the freezing temperatures. This dessert includes water, proteins, fat, sweetening agents and at least one stabilizing agent, with the sweetening agents forming a mixture which contains glucose and optionally fructose. These two compounds constitute, as a whole, from 6 to 30% of the total weight of the composition. The frozen dessert includes a nucleating agent, in particular microcrystalline cellulose. The invention relates, in addition, to a process for producing such a dessert, such a packaged dessert and a container for its packaging and its distribution.

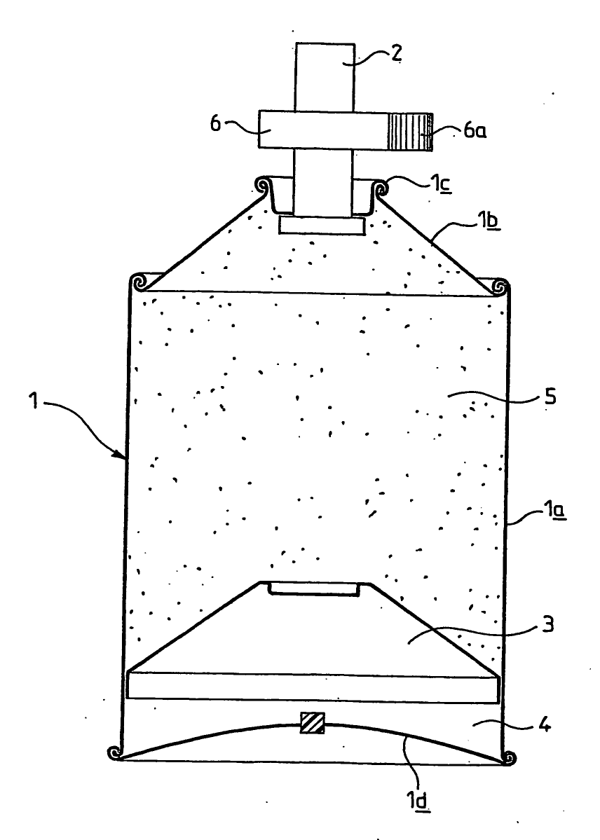

### CROSS-REFERENCE TO RELATED APPLICATIONS

This application is a continuation of International application PCT/EP02/10252 filed Sep. 9, 2002, the entire content of which is expressly incorporated herein by reference thereto.

### BACKGROUND

The invention relates to a frozen dessert of the type described in U.S. Pat. No. 6,558,729, the entire content of which is expressly incorporated herein by reference thereto. This type of frozen dessert generally comprises about 48% by weight of water relative to the total weight of the composition, the balance consisting essentially of proteins, fats, sweetening agents and at least one stabilizer. Such a frozen dessert may, depending on the needs, contain flavoring agents, coloring agents and edible inclusions. The product is obtained in the liquid state by mixing its constituents, generally in the hot state and with stirring, and then it is homogenized in order to obtain a homogeneous dispersion of fat globules having a small diameter. The preparation thus obtained is pasteurized (by an ultra-high temperature or UHT treatment, for example by direct injection of steam or spraying into steam) and then allowed to mature for a few hours, at a temperature of about 3° C. The preparation is then directly deep-frozen or placed in a pressurized container and then deep-frozen at a temperature which may be up to −18 or even −24° C.

As indicated in the abovementioned patent, the products previously obtained have, at their freezing point, a very hard consistency which prevents their immediate consumption and makes it practically impossible to divide them with a spoon, unless they are allowed time to warm up beforehand. The invention described in that patent attempts to avoid this drawback by providing a frozen dessert which is spoonable at the freezing temperature and which is capable of being distributed in a pressurized container; moreover, the product proposed in this patent has the organoleptic qualities of an ice cream, that is to say, in particular, a nonexcessive sweet taste and an absence of a greasy taste despite the presence of fat.

In this state of the art, it was indicated that the nature of the protein ingredients and their incorporation level have an influence on the texture of the frozen dessert at the freezing temperature: an incorporation level between 6 and 18% by weight relative to the whole formulation was suggested. It was also indicated that, to reduce the firmness of the product at freezing temperature, the level of incorporation of the fat and the nature thereof could be modified: an incorporation level of between 6 and 24% by weight relative to the total weight of the whole formulation was proposed and it was suggested to choose a fat with a low melting point such as sunflower oil for example; an increase in the level of incorporation of fat was observed, causing a deterioration of the taste of the product.

A choice of sweetening agents, namely a mixture of dextrose, fructose, invert sugar and glucose syrup has moreover been proposed in this state of the art. Given that the terms dextrose and glucose are synonymous and that invert sugar is a sucrose which has undergone hydrolysis to become a mixture of glucose and fructose, given, in addition, that glucose syrup consists of glucose, possibly of fructose, and of glucose polymer polysaccharides, it is observed that U.S. Pat. No. 6,558,729 recommends the use of a mixture of glucose, fructose and glucose syrup, a mixture in which the combination (glucose+fructose) should represent 6 to 30% by weight of the total sweetening agents.

The storage stability of a frozen dessert of the type described in U.S. Pat. No. 6,558,729 can be enhanced. Indeed, in such a frozen dessert of the state of the art, the water in the composition crystallizes during the freezing step but, over time, the size of the crystals increases substantially, without, however, the malleable and extrudable character of the product at freezing temperature disappearing completely. The phenomenon causes, however, a slight decrease in the malleability of the product and to ensure good malleability after a long period of storage, it is generally necessary to provide for a slight increase in the fat level. But in particular, when the water crystals develop in size, the product loses the unctuous structure which made it pleasant in the mouth and takes on a granular texture which is not generally acceptable to the consumer.

It is well known, in the state of the art, to incorporate into the composition of such a frozen dessert emulsifiers and thickeners, but such an incorporation does not make it possible to prevent the progress of the crystallization of the water. Accordingly, carboxymethylcellulose (CMC), which is conventionally used is a thickener in a proportion ranging from 0.1 to 0.4% by weight relative to the total weight of the composition, practically does not prevent the growth of ice crystals during storage.

Thus, improvements in these types of frozen desserts are needed, and these are provided by the present invention.

### SUMMARY OF THE INVENTION

The invention relates to a frozen dessert comprising a composition of partially frozen water, proteins, fat, sweetening agents and at least one stabilizing agent. The sweetening agents form a mixture which contains glucose and optionally fructose, with these two compounds constituting, as a whole, from 6 to 30% of the total weight of the composition. The stabilizing agent comprises a compound having a sufficiently small particle size to act as nucleating agent for water crystals during freezing of the composition so that the composition, independently of any incorporation of gas, is malleable and extrudable at freezing temperatures. The most preferred nucleating agent is microcrystalline cellulose.

The invention also relates to processes for making these frozen desserts. In one embodiment, the process includes mixing the proteins, sweetening agents, and stabilizing agent(s) with water to obtain a premix which is liquid at temperatures between about 25 and 70° C., and then adding the a fat to the premix with stirring. Alternatively, the process comprises mixing the proteins, fat and stabilizing agent(s) with water to obtain a premix which is liquid at temperatures between about 25 and 70° C., and then adding the sweetening agents and other ingredients to the liquid composition with stirring, with the water content being adjusted to between 40 and 60% by weight relative to the total weight of the composition.

In these processes, the resulting composition is homogenized at a pressure of between 10⁶ and 10⁷ Pascals and at a temperature of between 60 and 85° C.; the homogenized mixture is cooled to a temperature of between 0 and 10° C.; the cooled, homogenized preparation is matured for a period of between 1 and 24 h at a temperature of between 2 and 6° C., and the matured preparation, in liquid form, is packaged in a container while reducing temperature to a value of less than or equal to −15° C., thus nucleating water crystals during freezing of the composition; so that the composition, independently of any incorporation of gas, is malleable and extrudable at freezing temperatures.

The invention also relates to a frozen dessert which can be easily distributed in an overrun state, which comprises: a pressurized container, a malleable and extrudable frozen dessert in the frozen state and contained in the container; a propellant gas contained in the container and intended to urge the dessert out of the container, and means for distributing the frozen dessert from the container.

Also, the invention relates to a pressurized container for distributing the frozen dessert of the invention. The container comprises, in a chamber closed by distribution means, a sliding piston or a bag which separates, on the one hand, a pressurizing propellant gas and, on the other hand, the frozen dessert to be distributed, wherein the distribution means is arranged on one side of the piston or bag where the frozen dessert is present, in the vicinity of an end of the piston stroke or of the top of the bag.

### BRIEF DESCRIPTION OF THE DRAWINGS

The invention is further understood by reference to the single appended drawing FIGURE that depicts a device for distributing the frozen dessert of the invention.

### DETAILED DESCRIPTION OF THE PREFERRED EMBODIMENTS

In the context of the present invention, “freezing temperature” means the usual storage temperature used by a consumer of frozen products.

It has been found that the addition of the so-called “microcrystalline” cellulose can be added to frozen desserts with improved properties provided as a result. Surprisingly, the incorporation of microcrystalline cellulose (MCC) stabilizes the frozen dessert in question; in other words, with incorporation of MCC, the structure of the frozen dessert remains soft and pleasant in the mouth regardless of the storage time for which the frozen dessert is kept at the freezing temperature. It is thought that, without this explanation being in any way limiting, MCC acts as a nucleating agent and that, for a given quantity of water in the composition, the number of ice crystals is considerably increased, during freezing, such that these crystals, even if they subsequently change slightly, nevertheless remain at sufficiently small sizes for there to be no change in the pleasant character of the frozen dessert in the mouth.

The subject of the present invention is therefore a frozen dessert which, independently of any incorporation of gas, is malleable and extrudable at the usual storage temperature used by a consumer of frozen products, the composition constituting the dessert comprising water, proteins, fat, sweetening agents and at least one stabilizing agent, the sweetening agents forming a mixture which contains glucose and optionally fructose, these two compounds constituting, as a whole, from 6 to 30% of the total weight of the composition, characterized in that its composition comprises a stabilizing agent which acts as nucleating agent.

Generally, the dessert composition according to the invention contains from 40 to 62% by weight of water relative to the total weight of the composition, and more particularly about 57% by weight of water and 43% by weight of dry matter; the water content may be rapidly determined by a simple reading with a refractometer, subject to a correction of the measurements which is defined by calibration. The composition of the dessert according to the invention advantageously comprises from 0.1 to 1% by weight of microcrystalline cellulose (MCC) as nucleating agent relative to the total weight of the composition and 0.01 to 0.15% by weight of CMC relative to the total weight of the composition is preferably added thereto. The MCC used may be, for example, that sold by the company called “FMC Biopolymer France” under the trade name “AVICEL IC 2153”, in which case this commercial MCC contains an incorporation of 8 to 15% by weight of CMC relative to the total weight of the commercial product.

The inventors have, moreover, found that, surprisingly, it is possible to reduce the proportion of fat in a frozen dessert according to U.S. Pat. No. 6,558,729, without as a result limiting the malleability of the dessert at the freezing temperature, as long as, all things being equal in other respects, a mixture of sweetening agents is used of which at least 90% by weight consists of glucose, fructose and polymers of n molecules of glucose, n being an integer between 2 and 10 (inclusive), the polymers constituting from 10 to 50% of the weight of the mixture of sweetening agents. It was therefore observed that the presence, in the proportions indicated, of these glucose polymers makes it possible to avoid or reduce the greasy taste of the frozen dessert, which is favorable for the organoleptic qualities of the dessert, without as a result reducing, at the freezing temperature, its spoonable character and its capacity to be distributed by the nozzle of a pressurized container.

The fact that the mixture of sweetening agents contains from 10 to 50% of glucose polymers makes it possible to not only compensate for the reduction of the quantity of fat to be used in the composition of the frozen dessert according to the invention, but also a modification of the nature of the fat. Indeed, it becomes possible to use, as a mixture with fat, whose onset of solidification temperature is less than 0° C., a certain proportion of fat whose onset of solidification temperature is between 0 and 40° C., which allows greater flexibility in the taste of the frozen dessert according to the invention; it becomes, in particular, possible to use whole milk as source of proteins and no longer only skimmed milk as was the case in U.S. Pat. No. 6,558,729 because the fat in the milk can now partially replace the fat having an onset of solidification temperature of less than 0° C. It has been observed that it is possible to advantageously use, as glucose polymers, the polymer fraction, which exists in a glucose syrup containing from 30 to 40% by weight of glucose and less than 1% by weight of fructose. It has also been observed that the effect described above due to the glucose polymers can be reinforced by the addition of 1 to 5% by weight of dietary polyol(s), essentially glycerol and/or sorbitol, relative to the weight of the whole composition; it is nevertheless desirable to limit the quantity of glycerol or sorbitol because these products are not digestible and have some laxative effect.

It has been observed that, if the percentage of glucose increases in the composition, the frozen dessert obtained is more malleable; this is however limited by the fact that the frozen dessert should not have an excessively sweet taste. Likewise, the quantity of fructose incorporated into the composition is generally limited because fructose confers an excessively sweet taste on the frozen dessert. The sources of glucose which may be used for the manufacture of the dessert according to the invention are, in particular, standard glucose monohydrate, sucrose which has undergone acid hydrolysis (invert sugar) and glucose syrups. To obtain the more or less sweet taste of the dessert according to the invention, it is possible to modify the relative percentages of the various sources of sweetening agents in order to maintain the fructose at a sufficiently low level so that the taste is not too sweet and to maintain the glucose at a sufficiently high level in order to contribute to the malleability of the final product. As was previously indicated, the presence of glucose polymers in the mixture of sweetening agents is a factor which makes it possible to reduce the quantity of fat necessary for producing good malleability of the dessert according to the invention at the freezing temperature while minimizing the sweet taste. These glucose polymers contain from 2 to 10 molecules of glucose and the main source, which makes it possible to obtain them, consists of glucose syrups. Depending on the origins of the various glucose syrups, the relative quantity of these polymers relative to the total weight of the glucose syrup varies, as well as the distribution of the polymers in the whole polymer fraction.

The subject of the present invention is therefore also a frozen dessert which, independently of any incorporation of gas, is malleable and extrudable at the usual storage temperature used by a consumer of frozen products, the composition constituting the dessert comprising from 40 to 62% by weight of water and dry matter which contain proteins, fat, sweetening agents and at least one stabilizing agent, the sweetening agents forming a mixture, which contains glucose and optionally fructose, these two compounds constituting, as a whole, from 6 to 30% of the total weight of the composition, characterized in that the mixture, which constitutes the sweetening agents, consists, for at least 90% of its weight, in the first place, of glucose and the optional fructose, and, in the second place, of polymers of n molecules of glucose, n being an integer between 2 and 10 (inclusive), the polymers forming 10 to 50% of the weight of the mixture of sweetening agents.

The glucose polymers of the dessert according to the invention may advantageously consist of the mixture of polymers, which is obtained from a glucose syrup containing from 30 to 40% by weight of glucose and less than 1% by weight of fructose.

The composition according to the invention may advantageously comprise from 1 to 3% by weight of glycerol.

It is quite clear that the two improvements, which have been independently defined above as “subjects of the invention” may be used independently or simultaneously. In the three cases, the frozen dessert may have additional characteristics, which are mentioned below.

The fat in the composition may advantageously represent from 4 to 20% of the total weight of the composition. The fat which may be used may contain at least one fat of plant origin having an onset of solidification temperature of less than 0° C. and, optionally, one or more fats of plant or animal origin having an onset of solidification temperature of between 0 and 40° C. This possibility of adding fat having an onset of solidification temperature greater than 0° C. is highly linked to the presence, in the composition, of glucose polymers as indicated above, and, optionally, to the addition of glycerol or more generally of a dietary polyol. As fat of plant origin, a customary vegetable fat in the manufacture of ice creams may be used, for example cocoa fat. It is also possible to use at least one fat chosen from the group consisting of sunflower oil, sunflower oil rich in oleic acid, grapeseed oil and a butter oil fraction. The possibility of introducing fat having an onset of solidification temperature of between 0 and 40° C. makes it possible to use milk fat and, consequently, to use whole milk as source of proteins, which was not the case for the dessert according to U.S. Pat. No. 6,558,729. It is possible to add to the dessert composition according to the invention, as defined above, adjuvants, namely inclusions (for example fruit pieces) or flavoring preparations (for example based on chocolate or pistachio).

The frozen dessert according to the invention is provided in the form of an emulsion; advantageously, the dessert composition according to the invention contains at least one emulsion stabilizing agent chosen from the group consisting of emulsifiers and thickeners, all the stabilizing agents of the composition representing from 0.3 to 2.7% by weight relative to the total weight of the composition; the composition may contain at least one thickening agent chosen from the group consisting of carob, guar gum, carragheenans, alginates, gelatin, for example; among the emulsifiers which may be used, there may be mentioned mono- and diglycerides of fatty acids, sucroesters and egg yolk, for example.

It has been observed that, all things remaining equal in other respects, a sufficient malleability of the dessert according to the invention at the freezing temperature is obtained when the protein level in the composition is between 3 and 18% relative to the total weight of the composition of the dessert. Below 3%, the texture of the product is sufficiently fluid but the product lacks strength and stability. Above 18%, the product is no longer sufficiently malleable: the product is increasingly firm when the protein level is increased. The proteins which can be used may be proteins of plant origin and/or proteins of animal origin. When proteins of plant origin are used, it may be advantageously envisaged that they are obtained from leguminous plants, such as pea, lupin, wheat, maize, rice, lucerne or soybean. When the proteins are of animal origin, they may be provided by whole milk and/or skimmed milk and/or partially lactose-free milk and/or derivatives of milk origin. The derivatives of milk origin may be, in particular, powdered products mainly composed of proteins of serum origin and comprising 10 to 50% by weight of proteins. To reduce the risk of destabilization during storage due to crystallization of lactose, it is preferred that the derivatives of milk origin have practically no lactose or a low content of lactose, in particular of between 0% and 35% by weight.

The dessert composition according to the invention may also contain flavorings, polyols or sugar alcohols, ethanol or sugars other than glucose and fructose, all these ingredients being nevertheless in low quantities (of the order of a few percent of the total weight of the composition).

According to a first process which makes it possible to prepare the composition of which the frozen dessert consists according to the invention:

the protein sources, the sugars, the thickeners and the emulsifiers are mixed with water in order to obtain a premix which is liquid at a temperature of between 25 and 70° C. approximately;

the fat and the other ingredients are added, with stirring, and the composition thus obtained is homogenized at a pressure of between 10 and 120 bar and at a temperature of between 60 and 85° C.;

the mixture is cooled to a temperature of between 0 and 10° C. and the flavorings, if they were not added in the preceding step, are optionally added thereto;

the preparation is allowed to mature for a period of between 1 and 24 h at a temperature of between 2 and 6° C., and

the liquid preparation is packaged in a container and the temperature is reduced to a value of less than or equal to −15° C.

According to another process which makes it possible to prepare the composition, of which the frozen dessert according to the invention consists:

the sources of proteins, the fat, at least part of the stabilizers and in particular all or part of the CMC, if present, and the MCC, and optionally water, are mixed, with stirring, in order to obtain a premix which is liquid at a temperature of between 25 and 70° C. approximately;

the sweetening agents and all the other ingredients of the composition, in particular the egg yolk if present, with the exception of the optional flavorings, are added, with stirring, the water content is adjusted to a value chosen between 50 and 60% by weight relative to the total weight of the composition and the composition thus obtained is homogenized at a pressure of between 10⁶ and 10⁷ Pascals and at a temperature of between 60 and 85° C.;

the mixture is cooled to a temperature of between 0 and 10° C. and the optional flavorings are added;

the preparation is allowed to mature for a period of between 1 and 24 h at a temperature of between 2 and 6° C., preferably without stirring or mixing in order to optimize the organoleptic qualities of the product;

the liquid preparation is packaged in a container and the temperature is decreased to a value of less than or equal to −15° C.

It is also possible to use a process for preparing a standard mix, that is to say in which all the components are mixed in a single operation, without preparing a premix.

When it is desired to pasteurize or sterilize the composition, it is possible, just before or after the homogenization, to carry out a heat treatment by direct injection of steam into the composition or by indirect heat exchange for a period of up to 1 min or by spraying the composition into steam. In some cases, for compositions with a high dry matter content, it is possible to carry out a first homogenization with the pasteurization or sterilization step, and, consequently, the pasteurization or the sterilization is carried out between the two homogenizations.

It was observed that, for the frozen desserts according to the invention, it is preferable, for passing through the homogenizer, not to use extremely high pressures, or else the preparation obtained has the texture of an extremely firm cream, which has organoleptic qualities which are slightly different from those of a conventional ice cream. The product is packaged according to the method of marketing envisaged, that is to say, in particular, either in a pot, or in a container under pressure.

The subject of the present invention is therefore also a frozen dessert which can be easily distributed in an overrun state, characterized in that it comprises:

a pressurized container,

a malleable and extrudable frozen dessert in the frozen state, contained in the container and separated from the dessert,

a propellant gas contained in the container and intended to push the dessert out of the container, and

a means for distributing the dessert.

The subject of the present invention is also a pressurized container allowing the distribution of a frozen dessert according to the invention, characterized in that it comprises, in a chamber closed by a distribution means, a sliding piston which separates, on the one hand, a pressurizing propellant gas and, on the other hand, the frozen dessert to be distributed, the distribution means being arranged on the side of the piston where the frozen dessert is present, in the vicinity of one end of the piston stroke. According to a preferred embodiment, the dessert to be distributed, packaged in the container, contains, in the dissolved state, an overrun-producing gas so that the distributed frozen dessert does not have the texture of a compact cream but that of a slightly aerated cream, it being understood that the overrun should be maintained within a restricted limit so that the distributed product does not have the texture of a foam. Given the malleability characteristics of the frozen dessert according to the invention, the propellant gas should have, at the start of distribution, a pressure of between 5×10⁵ and 12×10⁵ Pascals, and the distribution means may have a passage cross section of between 125 and 300 mm², whose opening and closure are obtained by means of a rotating device or a device with a relocatable pusher.

It is observed that as long as microcrystalline cellulose is present as nucleating agent, there is a stable texture during storage, that is to say that the ice crystals, which are highly numerous because of the nucleation centers, do not change substantially, such that the frozen dessert keeps the same organoleptic characteristics during storage.

It was observed, moreover, that the presence of glucose polymers makes it possible to reduce the quantity of fat introduced into the composition without, as a result, the malleability of the product being thereby affected.

It was finally observed that the two phenomena indicated above occur whether fructose is present in the composition or not; nevertheless, the presence of fructose generates, for the final product, a very sweet taste, which may be considered, in some cases, undesirable, which generally leads to the proportion of fructose used being considerable limited so that the product has optimum organoleptic qualities.

### EXAMPLES

The examples below illustrate compositions according to the invention.

### Example 1

A composition according to the invention is prepared which corresponds to the following formulation (% given by weight):

| | |
|---|---|
| Sunflower oil | 14.5% |
| Whole milk powder | 5% |
| Derivative of milk origin (origin = demineralized | 4% |
| and hydrolyzed milk serum, | |
| contains 41% of proteins and 22% of lactose) | |
| Glucose | 8% |
| Glucose syrup (containing 35% of glucose and | 10% |
| 65% of glucose polymers having 2 to 10 | |
| monomer units) | |
| Emulsifier E 471 | 0.3% |
| Gelatin | 0.2% |
| CMC | about |
| | 0.03% |
| MCC | about |
| | 0.27% |
| Glycerol | 1.5% |
| Sorbitol | 1.5% |
| Egg yolk | 2% |
| Strawberry flavor | 0.2% |
| Liquid whole milk (qs 100%) | 52.5% |

The composition according to the above formulation is prepared by mixing, at 60° C. with stirring, the skimmed milk powder and the stabilizers (except the egg yolk), the sunflower oil and three-quarters of the liquid milk of the composition and then adding the glucose, the glucose polymers and all the other ingredients of the composition, including the remainder of the liquid milk. The composition is pasteurized by direct injection of steam at 90° C. The mixture is homogenized at a pressure of 2×10⁶ Pascals and at a temperature of 70° C. The mixture obtained is cooled to 3° C.; the preparation is then allowed to mature at 3° C. without any stirring or mixing for 12 hours. The product obtained is packaged in a pressurized container of the type represented in the single FIGURE of the accompanying drawing, which shows a schematic axial section of the container, and the temperature is reduced to −18° C.

### Example 2

A composition according to the invention is prepared which corresponds to the following formulation (% given by weight):

| | |
|---|---|
| Vegetable fat | 10.9% |
| Whole milk powder | 7.35% |
| Derivative of milk origin | 10.9% |
| Glucose and glucose syrup | 16.1% |
| Emulsifier | 0.38% |
| Thickener | 0.13% |
| Colorings and flavorings | 0.08% |
| Water | 54.16% |

To prepare the composition, the procedure is carried out according to Example 1, except that all the components are mixed in a single operation, without preparing a premix and that the heat treatment is carried out by indirect exchange.

A frozen dessert distributor according to the invention is illustrated in the sole appended drawing FIGURE. The packaging container is designated by 1 in its entirety: it comprises a cylindrical body 1a surmounted by a frustoconical dome 1b, which carries, at its small sectional end, a seamed cup 1c at the center of which a distribution means 2 is attached which has an outlet section of 200 mm², the section for passage of the product into the distribution means 2 being substantially constant and equal to the outlet section indicated above. The opening and closing of the distribution means 2 are provided by a rotating device 6 operated by the consumer by means of a wing 6a, or by a relocatable device.

A sliding piston 3 is housed in the body 1a. Between the base 1d of the container and the piston 3, a propellant gas consisting of nitrogen at a pressure of 10⁶ Pascals (pressure at the start of distribution) was introduced. Between the piston 3 and the distribution means 2, the frozen dessert 5 according to the invention, obtained as indicated above, is placed: in this dessert, an overrun-producing gas, nitrous oxide (N20), was dissolved, before freezing, in an appropriate quantity to generate overrun at the time of distribution.

Under these conditions, the distribution occurs without difficulty from the start to the end and the dessert according to the invention thus distributed possesses all the organoleptic qualities desired by the consumer and malleability at a temperature of less than −15° C. and perfect stability during storage.

What is claimed is:

1. A frozen dessert comprising a composition of partially frozen water, proteins, fat, sweetening agents and at least one stabilizing agent, with the sweetening agents forming a mixture which contains glucose and optionally fructose, these two compounds constituting, as a whole, from 6 to 30% of the total weight of the composition, and with the stabilizing agent comprising a compound having a sufficiently small particle size to act as nucleating agent for water crystals during freezing of the composition so that the composition, independently of any incorporation of gas, is malleable and extrudable at freezing temperatures.

2. The dessert of claim 1, wherein the stabilizing agent comprises microcrystalline cellulose in an amount of from 0.1 to 1% by weight relative to the total weight of the composition.

3. The dessert of claim 1, wherein the partially frozen water is present in an amount of from 40 to 62% by weight relative to the total weight of the composition.

4. The dessert of claim 1, wherein the at least one stabilizing agent includes an emulsifier or thickener, with all stabilizing agents being present in an a mount of from 0.3 to 2.7% by weight relative to the total weight of the composition.

5. The dessert of claim 4, wherein the thickener is carob gum, guar gum, a carragheenan, an alginate, gelatin, a carboxymethylcellulose (CMC) and the emulsifier is a mono or and diglycerides of a fatty acid, a sucroester or egg yolk.

6. The dessert of claim 1, wherein the mixture of sweetening agents comprises at least 90% of its weight of glucose and the optional fructose, and includes polymers of n molecules of glucose, n being an integer between 2 and 10, inclusive, with the polymers representing from 10 to 50% of the weight of the mixture of sweetening agents.

7. The dessert of claim 6, wherein the glucose polymers are present in an amount of 60 to 70% along with a glucose syrup containing from 30 to 40% by weight of glucose and less than 1% by weight of fructose.

8. The dessert of claim 1, wherein the composition further comprises from 1 to 3% by weight of glycerol.

9. The dessert of claim 1, wherein fat is present in the composition in an amount of from 4 to 20% by weight relative to the total weight of the composition.

10. The dessert of claim 1, wherein the fat contains at least one fat of plant origin having an onset of solidification temperature of less than 0° C. and, optionally, one or more fats of plant or animal origin having an onset of solidification temperature of between 0 and 40° C.

11. The dessert of claim 10, wherein the fat is chosen from the group consisting of sunflower oil, sunflower oil rich in oleic acid, grapeseed oil and a butter oil fraction.

12. The dessert of claim 1, wherein the proteins are present in an amount of from 3 to 18% by weight relative to the total weight of the composition.

13. The dessert of claim 12, wherein the proteins are proteins of plant origin or proteins of animal origin provided by whole, skimmed or partially lactose-free milk or a derivative of milk origin.

14. The dessert of claim 13, wherein the derivatives of milk origin are demineralized whey or demineralized and lactose-free whey.

15. The dessert of claim 13, wherein the proteins of plant origin are obtained from leguminous plants.

16. The dessert of claim 1, which further comprises adjuvants, flavoring inclusions or other preparations.

17. A process for manufacturing a frozen dessert which comprises:
mixing proteins, sweetening agents, and stabilizing agent(s) with water to obtain a premix which is liquid at temperatures between about 25 and 70° C., wherein the sweetening agents form a mixture which contains glucose and optionally fructose, these two compounds constituting, as a whole, from 6 to 30% of the total weight of the composition, and the stabilizing agent comprises a compound having a sufficiently small particle size to act as nucleating agent for water crystals during freezing of the composition;
adding a fat to the premix with stirring, and homogenizing the resulting composition at a pressure of between 10⁶ and 10⁷ Pascals and at a temperature of between 60 and 85° C.;
cooling the homogenized mixture to a temperature of between 0 and 10° C.;
maturing the cooled, homogenized preparation for a period of between 1 and 24 h at a temperature of between 2 and 6° C., and
packaging the matured preparation, in liquid form, in a container while reducing temperature to a value of less than or equal to −15° C., thus nucleating water crystals during freezing of the composition; so that the composition, independently of any incorporation of gas, is malleable and extrudable at freezing temperatures.

18. The process of claim 17, wherein the stabilizing agents include emulsifiers and thickening agents, and which further comprises adding flavorants and other adjuvants or additives after cooling of the homogenized mixture.

19. The process of claim 17, which further comprises pasteurizing or sterilizing just before or after homogenizing by direct injection of steam, by spraying the composition into steam or by indirect heat exchange for a period of up to 1 minute.

20. A process for manufacturing a frozen dessert which comprises:
mixing proteins, a fat and stabilizing agent(s) with water to obtain a premix which is liquid at temperatures between about 25 and 70° C., wherein the stabilizing agent comprises a compound having a sufficiently small particle size to act as nucleating agent for water crystals during freezing of the composition;
adding sweetening agents and other ingredients to the liquid composition with stirring, with the water content being adjusted to between 40 and 60% by weight relative to the total weight of the composition, wherein the sweetening agents form a mixture which contains glucose and optionally fructose, these two compounds constituting, as a whole, from 6 to 30% of the total weight of the composition;
homogenizing the resulting liquid composition at a pressure of between 10⁶ and 10⁷ Pascals and at a temperature of between 60 and 85° C.;
cooling the homogenized mixture to a temperature of between 0 and 11° C.;
maturing the cooled, homogenized preparation for a period of between 1 and 24 h at a temperature of between 2 and 6° C., and
packaging the matured preparation, in liquid form, in a container while reducing temperature to a value of less than or equal to −15° C., thus nucleating water crystals during freezing of the composition; so that the composition, independently of any incorporation of gas, is malleable and extrudable at freezing temperatures.

21. The process of claim 20, wherein the stabilizing agents include emulsifiers and thickening agents, and which further comprises adding flavorants and other adjuvants or additives after cooling of the homogenized mixture.

22. The process of claim 19, which further comprises pasteurizing or sterilizing just before or after homogenizing by direct injection of steam, by spraying the composition into steam or by indirect heat exchange for a period of up to 1 minute.

23. A frozen dessert which can be easily distributed in an overrun state, which comprises:
a pressurized container,
a malleable and extrudable frozen dessert in the frozen state and contained in the container;
a propellant gas contained in the container and intended to urge the dessert out of the container, and
means for distributing the frozen dessert from the container.

24. A frozen dessert which can be easily distributed in an overrun state, which comprises:
a pressurized container,
a malleable and extrudable frozen dessert according to claim 1 and being in the frozen state and contained in the container;
a propellant gas contained in the container and intended to urge the dessert out of the container, and
means for distributing the frozen dessert from the container.

25. A pressurized container allowing the distribution of the frozen dessert of claim 1, which comprises, in a chamber closed by distribution means, a sliding piston or a bag which separates, on the one hand, a pressurizing propellant gas and, on the other hand, the frozen dessert to be distributed, wherein the distribution means is arranged on one side of the piston or bag where the frozen dessert is present, in the vicinity of an end of the piston stroke or of the top of the bag.

26. The container of claim 25, wherein the frozen dessert contains an overrun-producing gas, optionally in a dissolved state.

27. The container of claim 25, wherein the propellant gas has a pressure, at the start of distribution, of between 5×10⁵ and 12×10⁵ Pascals, and the distribution means has a passage cross section of between 125 and 300 mm², whose opening and closure are obtained by means of a rotating device or a device with a relocatable pusher.
